(19) United States
(12) Patent Application Publication
(10) Pub. No.: US 2007/0067399 A1
(43) Pub. Date: Mar. 22, 2007

(54) Electronic mail archiving system and method

(76) Inventors: Raghavendra Kulkarni, West Hills, CA (US); Rajesh Ramani, Simi Valley, CA (US)

Correspondence Address: Ketan S. Vakil, Esq.;SNELL & WILMER L.L.P., Suite 1400, 600 Anton Boulevard, Costa Mesa, CA, 92626-7689, US

(21) Appl. No.: 11/232,632

(22) Filed: Sep. 22, 2005

(51) Int. Cl. G06F 15/16

(52) U.S. Cl. 709/206

(57) ABSTRACT

A system and method for real-time or nearly real-time archiving of electronic mail (“email”) messages resulting in a more secure archiving process with minimal or no loss of email messages by accidental deletion or during an event such as a computer crash is disclosed. A copy of each email message is sent, via an email archive plug-in, to an email archive located remotely from the user's computer and the email server that sent the email message to the user's computer. The archived copies of email messages may be kept confidential by optionally encrypting and/or compressing the email messages to ensure that unauthorized person do not have access to the email messages. Furthermore, copies that are already encrypted and/or compressed when received by the email archive plug-in, may be kept in their encrypted and/or compressed state or may decrypted and/or decompressed prior to storage.

### FIELD OF THE INVENTION

The present invention generally relates to electronic mail (“email”), and particularly to, systems and methods for storing and recovering email messages.

### BACKGROUND OF THE INVENTION

Backup systems for electronic mail (“email”) messages have been used for some time. Current systems (e.g., enterprise email systems) have built in capabilities to back up email messages, however, these systems back-up on a regular basis (e.g., daily, weekly, and the like) from a central email messaging server. While such systems work reasonably well in recovering “lost” email messages from the backup files, recovery of email messages from backup data files are usually point in time restores, and not continual backups. Since backups are not continuous and are usually done in specific intervals (e.g., once a week, once a day, etc.), some email messages that are sent and received between these backups may get lost, for example, when a computer crashes or the user accidentally/inadvertently deletes one or more email messages.

Moreover, other systems (e.g., UNIX/LINUX based email systems) perform back-ups, but do not store email messages after the email messages have been read by the user. Thus, the email message becomes “lost” if the user deletes or somehow loses the email message after reading it.

In addition, there are situations where it is desirable to keep confidential information in email messages. With central email servers, the email messages and email message backups are not stored encrypted. Without being encrypted, one or more individuals with administrator privileges on these systems have access to confidential information contained within the email messages and/or backup files. Since various regulations (e.g., the Health Insurance Portability Act (HIPPA)) insist on confidentiality of information stored and transmitted, current email systems are not eligible for transferring and/or storing certain types of data. Thus, there is a need in the art for systems, apparatus, and methods of archiving email messages in substantially real-time, or as soon as or before an email is read by the user, and in an encrypted format to restrict unauthorized access to the email messages.

### SUMMARY OF THE INVENTION

The present invention provides, inter alia, an incremental backup system, apparatus, and method capable of backing up and restoring electronic mail (“email”) messages. The email user utilizes an email platform (e.g., Microsoft Outlook or Microsoft Outlook Express) running on the user's computer. To backup the user's email messages, the email messages are stored on another computer (“remote computer” or “destination computer”) that is either directly or indirectly attached to the primary computer via, for example, a local area network (LAN), a wide area network (WAN), or the Internet. In other words, the email messages are stored remotely from the user's computer. The remotely stored email messages may be stored either in an uncompressed, unencrypted format (“native format”), in a compressed format, an encrypted format, or in a compressed, encrypted format.

Furthermore, an index file may be used on the destination computer to keep track of a list of email messages and/or the information related to each email message (e.g., a header including the date and time received, message ID, and the like). The index file may facilitate restoration of email messages back to the user in the email-receiving folder (“Inbox”) or in other formats (e.g., plain text format). Moreover, the email messages may be individually restored or restored in a batch.

The system and/or method may also provide the ability for compression and encryption of archived email messages to ensure that unauthorized people do not have access to the email messages. To accomplish this, the system may encrypt and/or compress email messages prior to storage in the index file or, if the email messages are already encrypted and/or compressed, store the email messages in their encrypted and/or compressed format.

### BRIEF DESCRIPTION OF THE DRAWINGS

The figures illustrate various embodiments of the present invention by way of example, and not by way of limitation. Embodiments of the present invention may include part or all of the features shown in one of these figures, or may include features from two or more figures. Embodiments of the present invention may also include features described in the specification, or elements of features described in the specification. Furthermore, embodiments of the present invention may include features that would be familiar to a person of ordinary skill in the art having studied this document. Thus, a more complete understanding of the present invention may be derived by referring to the detailed description and claims when considered in connection with the drawing figures, where like reference numbers refer to similar elements throughout the figures, and

FIG. 1 is a block diagram of an exemplary embodiment of a system for backing up electronic mail (“email”) messages;

FIG. 2 is a flow diagram of one exemplary embodiment of a method for backing up email messages;

FIG. 3 is a flow diagram of an exemplary embodiment of a method for retrieving backed-up email messages; and

FIG. 4 is a flow diagram of another exemplary embodiment of a method for backing up and retrieving email messages.

### DETAILED DESCRIPTION OF THE INVENTION

The detailed description of exemplary embodiments herein makes reference to the accompanying drawings, which show various exemplary embodiments by way of illustration. While these exemplary embodiments are described in sufficient detail to enable those skilled in the art to practice the invention, it should be understood that other embodiments may be realized and that logical and/or mechanical changes may be made without departing from the spirit and scope of the invention. Thus, the detailed description herein is presented for purposes of illustration and not by way of limitation. For example, the steps recited in any of the method or process descriptions may be executed in any order and are not limited to the order presented. Moreover, any of the functions or steps may be outsourced to or performed by one or more third parties.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical connections between the various elements. It should be noted that many alternative and/or additional functional relationships, or physical connections may be present in a practical system.

The present invention includes systems, apparatus, and methods of storing electronic mail (“email”) messages for backup storage. Several systems, apparatus, and methods exist for storing email messages on a data storage repository. However, these methods backup emails from a user's email folder at predetermined time intervals (e.g., daily, weekly, monthly, and the like), whereas the uniqueness of various embodiments of the present invention include methods to archive email messages at a remote storage facility in substantially real-time, as soon as the email messages are downloaded from an email server, or as soon as the email messages are read by a user utilizing an email platform (e.g., Microsoft Outlook or Microsoft Outlook Express). Additionally, the present invention offers protection against accidental deletion of email messages or email messages “lost” (e.g., by a computer crash) between scheduled backups by making sure email messages that are downloaded by the email platform are immediately flagged for archiving before the user performs any action (e.g., reading, deletion, forwarding, and the like) on the email messages.

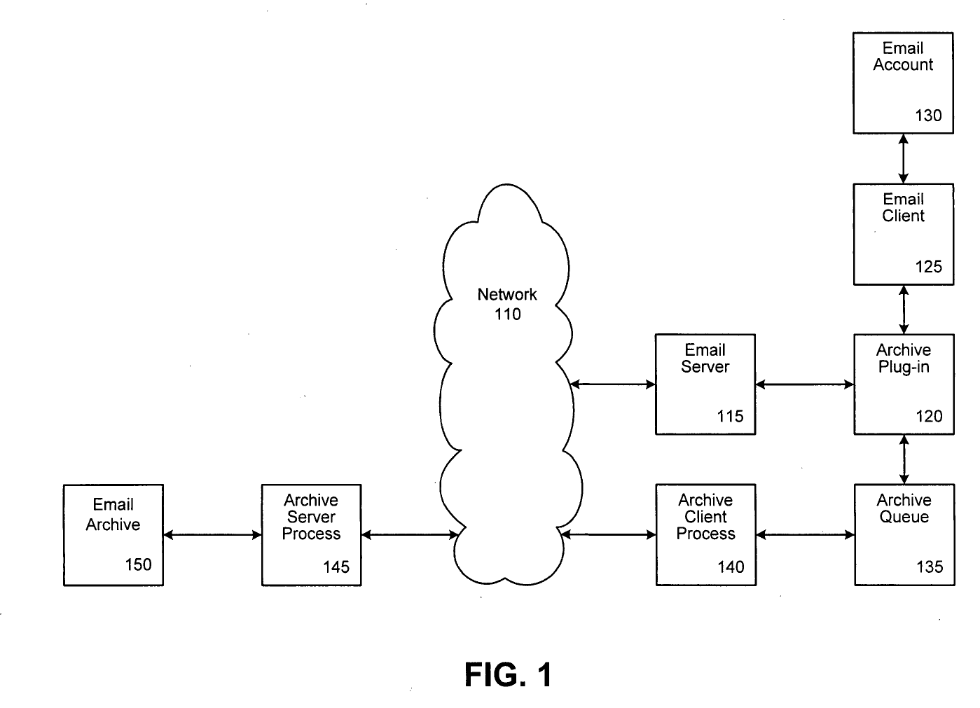

FIG. 1 is a block diagram of an exemplary embodiment of a system 100 for backing up electronic mail (“email”) messages. System 100 includes a network 110 in communication with an email server 115. Network 110 may include any electronic communication method incorporating hardware and/or software components of such. Network 110, in accordance with one exemplary embodiment of the invention, is the Internet. Notably, specific information related to the protocols, standards, and application software utilized in connection with the Internet are generally known to those skilled in the art and, as such, is not detailed herein. For information relating to the protocols, standards, and application software utilized in connection with the Internet, see, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

In various other exemplary embodiments, network 110 maybe a telephone network, an extranet, an intranet, a kiosk, online communications, satellite communications, off-line communications, wireless communications, transponder communications, a local area network (LAN), a wide area network (WAN), one or more networked or linked computing devices, and/or any other suitable communication or data input modality. Notably, system 100 may be implemented with TCP/IP communications protocols, utilizing IPX, Appletalk, IP-6, NetBIOS, OSI, or any number of existing or future protocols. Furthermore, the various system components (e.g., email server 115, archive client process 140, and archive server process 145) may be independently, separately, or collectively in communication with network 110 via data links which includes, for example, a connection to an Internet Service Provider (ISP) over a local loop as is typically used in connection with standard modem communication, cable modem, Dish networks, ISDN, Digital Subscriber Line (DSL), or various other wireless communication methods (see, for example, GILBERT HELD, UNDERSTANDING DATA COMMUNICATIONS (1996), which is hereby incorporated by reference). Moreover, the invention contemplates that network 110 may be implemented as other types of networks such as, for example, an interactive television (ITV) network.

Email server 115 may be any hardware and/or software suitably configured to manage email messages for one or more users. As such, email server 115 may be any email server known in the art or developed in the future. In accordance with various exemplary embodiments of the invention, email server 115 is an email server utilizing post office protocol (e.g., POP2 or POP3), internet message access protocol (IMAP), hyper text transfer protocol (HTTP), or any other protocol suitable for managing email messages.

In accordance with another exemplary embodiment of the invention, email server 115 is in communication with an archive plug-in 120. Archive plug-in 120 may be any hardware and/or software suitably configured to communicate with, and work in conjunction with, an email client 125 to capture email messages and perform one or more functions to the email messages. Specifically, archive plug-in 120 is a program that attaches itself to email client 125 or may be a program that is external to email client 125 to provide additional functionality such as, for example, copying captured email messages and transmission of the captured email messages to a long-term storage device.

Archive plug-in 120, in accordance with one exemplary embodiment of the invention, is configured to capture an incoming email message (in part or entirely), and transmit a copy of the email message to email client 125 and a copy of the email message to an archive queue 135 as the email message is read from email server 115. In another exemplary embodiment, archive plug-in 120 is configured to capture an email message (in part or entirely) and transmit a copy of the email message to email client 125, and transmit a copy of the email message to archive queue 135 when the email message is saved in the user's email folder by in email client 125. In yet another exemplary embodiment, archive plug-in 120 is configured to capture an email message (in part or entirely) and transmit a copy of the email message to email client 125, and transmit a copy of the email message to archive queue 135 prior to the email message being saved in the user's email folder by email client 125.

Email client 125 may be any hardware and/or software suitably configured to send and/or receive email messages for an email account 130 of a user. As such, email client 125 may be any email client known in the art of developed in the future. In accordance with one exemplary embodiment of the invention, email client is Microsoft Outlook or Microsoft Outlook Express manufactured by Microsoft Corporation of Redmond, Wash.

Archive queue 135 may be any hardware and/or software suitably configured to temporarily or permanently store email messages pending be archived. As such, archive queue 135 may be any archive queue known in the art or developed in the future. In various embodiments, archive queue 135 is a computer's memory, a hard disk, a network drive, or other suitable storage device. In accordance with one exemplary embodiment of the invention, archive queue 135 is a folder on the user's hard disk (e.g., c-drive).

In accordance with one exemplary embodiment of the invention, archive queue 135 is in communication with an archive client process 140. Archive client process 140 may be any hardware and/or software suitably configured to prepare email messages for transmission to an archive server process 145. As such, archive client process 140 may be any archive client process known in the art or developed in the future. In accordance with one exemplary embodiment of the invention, archive client process 140 is configured to check archive queue 135 for new email messages, read email messages, and transmit the email messages to archive client process 140 on a periodic or continual basis. In another exemplary embodiment, archive client process 140 is configured to compress email messages and/or encrypt email messages prior to transmitting the email messages to archive server process 145. Archive client process 140, in yet another exemplary embodiment, is configured to package multiple email messages into a compressed or raw format, and send the email messages to archive server process 145.

Archive server process 145 is any hardware and/or software suitably configured to store email messages in an email archive 150. As such, Archive server process 145 may be any archive server process known in the art or developed in the future. In accordance with one exemplary embodiment of the invention, archive server process 145 is a computer program that resides on another computer in the LAN, WAN, the Internet, or on the same computer as email client 125.

In another exemplary embodiment of the invention, archive server process 145 is in communication with email archive 150, wherein email archive 150 is any hardware and/or software suitably configured to store email messages. In accordance with one exemplary embodiment of the invention, email archive 150 is a storage area attached to the computer running archive server process 145 or on a network storage device. Moreover, email archive 150 may be a file index, index, or database suitably configured to store email messages. As such, email archive 150 may be any storage device known in the art or developed in the future capable of storing email messages.

In operation, system 100 functions to receive email messages from network 110 via email server 115. The email messages are then transmitted to archive plug-in 120 where a copy of the email message is sent to email client 125 and a copy sent to archive queue 135. The email message is sent to email account 130 for the user to read and/or perform other functions. After the message is queued in archive queue 135, archive client process 140 periodically or continuously checks archive queue 135 for new messages and reads the email messages. Furthermore, archive client process 140 optionally compresses and/or encrypts the email messages, and also optionally packages multiple emails into a compressed or raw format, and then sends the email messages to archive server process 145 via network 110. Archive server process 145 receives and stores the email messages in email archive 150 for future retrieval.

Notably, the various components of system 100 discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various file indexes and/or databases used herein may include: client data; merchant data; and/or similar data useful in the operation of system 100 in addition to storing email messages.

As those skilled in the art will appreciate, any computers utilized by a user may include an operating system (e.g., Windows NT, 95/98/2000, OS2, UNIX, Linux, Solaris, MacOS, etc.) as well as various conventional support software and drivers typically associated with computers. The computer may include any suitable personal computer, network computer, workstation, minicomputer, mainframe or the like. User computers may be in a home or business environment with access to network 110 through a commercially-available web-browser software package.

As will be appreciated by one of ordinary skill in the art, system 100 may be embodied as a customization of an existing system, an add-on product, upgraded software, a stand alone system, a distributed system, a method, a data processing system, a device for data processing, and/or a computer program product. Accordingly, system 100 may take the form of an entirely software embodiment, an entirely hardware embodiment, or an embodiment combining aspects of both software and hardware. Furthermore, system 100 may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

System 100 also contemplates use in association with web services, utility computing, pervasive and individualized computing, security and identity solutions, autonomic computing, commodity computing, mobility and wireless solutions, open source, biometrics, grid computing and/or mesh computing. In addition, any file index, index, or database discussed herein may include relational, hierarchical, graphical, or object-oriented structure and/or any other file index configurations. Common file index products that may be used to implement the file indexes include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable file index product. Moreover, the file indexes may be organized in any suitable manner, for example, as data tables or lookup tables. Each email message may be a single file, a series of files, a linked series of data fields, or any other data structure. Association of certain email messages may be accomplished through any desired data association technique such as those known or practiced in the art. For example, the association may be accomplished either manually or automatically. Automatic association techniques may include, for example, a file index search, a file index merge, GREP, AGREP, SQL, using a key field in the tables to speed searches, sequential searches through all the tables and files, sorting records in the file according to a known order to simplify lookup, and/or the like. The association step may be accomplished by a file index merge function, for example, using a “key field” in pre-selected file indexes or data sectors.

More particularly, a “key field” partitions the file index according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, and the like.

In one exemplary embodiment, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the financial transaction instrument by multiple and unrelated owners of the data sets. For example, a first data set which may be stored may be provided by a first party, a second data set which may be stored may be provided by an unrelated second party, and yet a third data set which may be stored, may be provided by a third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, in one exemplary embodiment, the data set (e.g., BLOB) may be annotated in a standard manner. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

One skilled in the art will also appreciate that, for security reasons, any file indexes, systems, devices, servers, databases, or other components of system 100 may consist of any combination thereof at a single location or at multiple locations, wherein each file index or system includes any of various suitable security features, such as firewalls, access codes, encryption, decryption, compression, decompression, and/or the like.

System 100 may be further equipped with an Internet browser connected to the Internet or an intranet using standard dial-up, cable, DSL or any other Internet protocol known in the art. Transactions originating outside system 100 may pass through a firewall in order to prevent unauthorized access from users of other networks. Further, additional firewalls may be deployed between the varying components of system 100 to further enhance security.

The firewall(s) may include any hardware and/or software suitably configured to protect system 100 components from users of other networks. As such, the firewall may be configured to limit or restrict access to various systems and components behind the firewall. The firewall may reside in varying configurations including Stateful Inspection, Proxy based and Packet Filtering, among others. The firewall may be integrated within a web server or any other system 100 component(s), or may further reside as a separate entity (not shown).

Any computing devices discussed herein may provide a suitable website or other Internet-based graphical user interface which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system.

Any of the communications, inputs, storage, file indexes or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), helper applications, plug-ins, and the like. A server may include a web service that receives a request from a web server, the request including a URL (http://yahoo.com/stockquotes/ge) and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

Practitioners will also appreciate that there are a number of methods for displaying email messages within a browser-based document. Email messages may be represented as standard text or within a fixed list, scrollable list, drop-down list, editable text field, fixed text field, pop-up window, and the like. Likewise, there are a number of methods available for modifying email messages such as, for example, free text entry using a keyboard, selection of menu items, check boxes, option boxes, and the like.

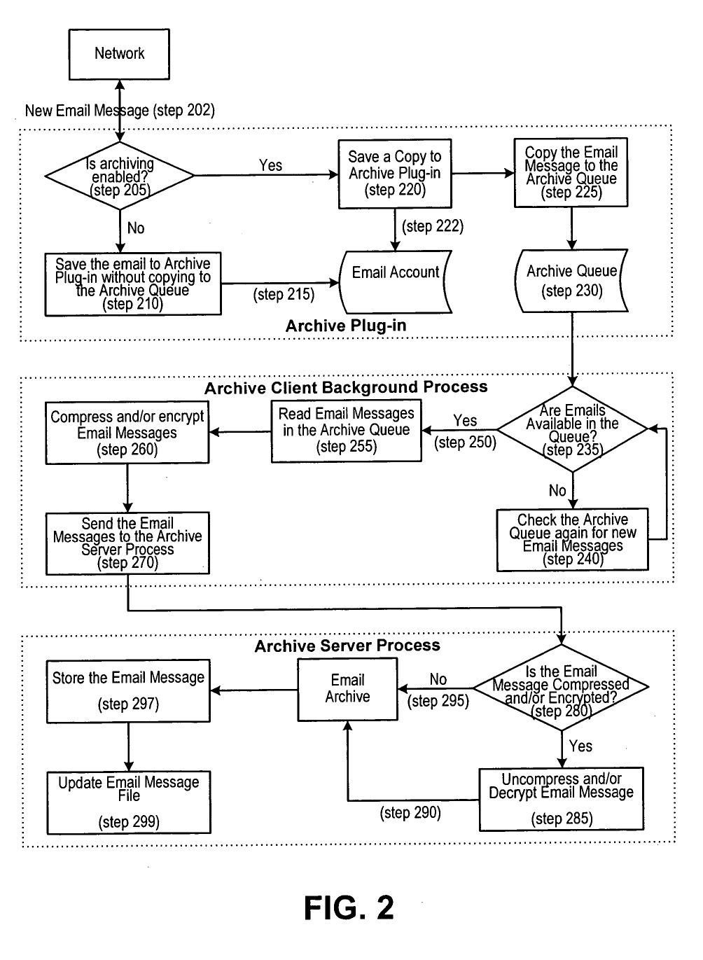

Referring now to FIGS. 2-4, the process flows and screenshots depicted are merely embodiments and are not intended to limit the scope of the invention as described herein. For example, the steps recited in any of the method or process descriptions may be executed in any order and are not limited to the order presented. It will be appreciated that the following description makes appropriate references not only to the steps depicted in FIGS. 2-4, but also to the various system components as described above with reference to FIG. 1.

FIG. 2 is a flow diagram of one exemplary embodiment of a method 200 for backing up email messages. In accordance with one exemplary embodiment of the invention, method 200 initiates by an email server (e.g., email server 115) receiving an email message from a network (e.g., network 110) (step 202). Email server 115 determines whether email message archiving is available (step 205). If archiving is unavailable, the email message is saved (partially or completely) to an email folder within an archive plug-in (e.g., archive plug-in 120) without copying the email message to an archive queue (e.g., archive queue 135) (step 210) and is then transmitted to a user's email account (e.g., email account 130) (step 215). If archiving is available, a copy of the email message is saved (partially or completely) to an incoming email message folder of archive plug-in 120 (step 220), a copy of the email message is transmitted to email account 130 (step 222), and a copy of the email message is transmitted to archive queue 135 (step 225).

Archive queue 135 receives the copy of the email message (step 230), and then an archive client process (e.g., archive client process 140) checks archive queue to determine whether there are email messages available in archive queue 135 (step 235). Archive client process 140 will continually or periodically check archive queue 135 for new messages (step 240). When an email message is available in archive queue 135, archive client process 140 reads the email message (step 255) and optionally compresses and/or encrypts the email message (step 260). The email message is then transmitted to an archive server process (e.g. archive server process 145) (step 270).

Archive server process 145 checks to determine if any email messages are compressed and/or encrypted (step 280). Compressed and/or encrypted email messages are uncompressed and/or decrypted (step 285) and transmitted to an email archive (e.g., email archive 150) (step 290). Email messages that are not compressed and encrypted are transmitted to email archive 150 (step 295). Notably, steps 285 and 290 may be omitted in embodiments capable of storing compressed and/or encrypted email messages. Email archive 150 stores the email message for future retrieval (step 297). In accordance with one exemplary embodiment of the invention, the email messages are organized in folders and subfolders that identify the original source folder, the time the emails were originally sent, subject, sender or any other way to organize/identify the email messages.

Furthermore, the email message may be updated to include new/different information for retrieving the email message (step 299). Notably, the email message may be updated to include an optional index, new headers, a classification, or any other information that might make it easier to find and retrieve the email message. Moreover, the email messages may be stored as individual files or within a file including multiple email messages.

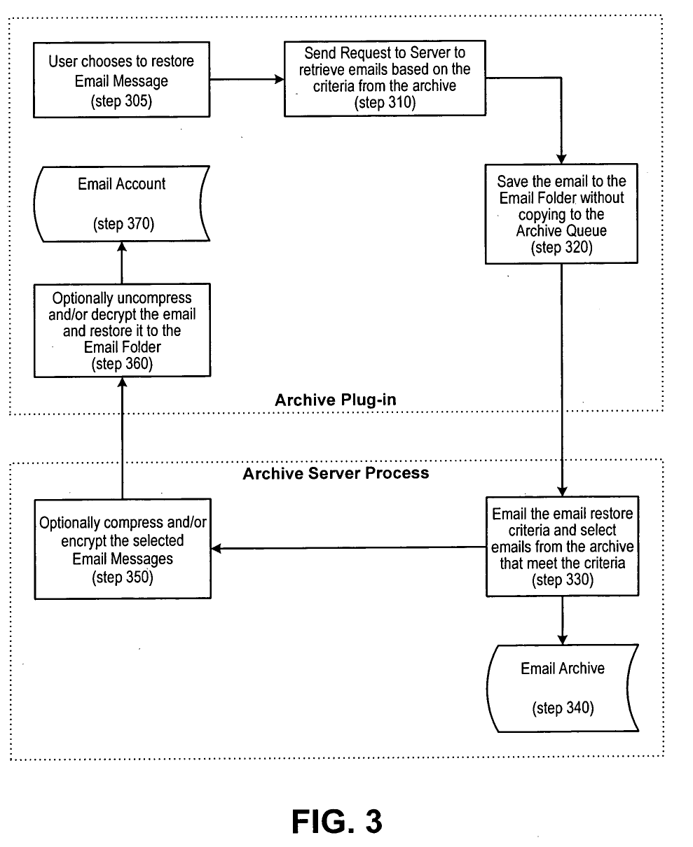

FIG. 3 is a flow diagram of an exemplary embodiment of a method 300 for retrieving backed-up email messages. In accordance with one exemplary embodiment of the invention, method 300 initiates by a user choosing to retrieve/restore an email message (step 305). In one embodiment, the user conducts the search utilizing archive plug-in 120, however, the invention contemplates that any other device and/or software may be used to search for stored email messages.

The user may search for the email message by any criteria under which the email message was stored. For example, the criteria may be to restore all the email messages in email archive 150, or a sub-set of the email messages stored in email archive 150 based on the source folder, date and time when the email messages were originally sent, subject, sender, or any other appropriate criteria. Once the criteria is selected and the user proceeds with the restoration of the selected emails, archive plug-in 120 either directly or indirectly requests email process server 145 to restore any email messages that include the selected criteria (step 310). Archive plug-in 120 receives the email message(s) and then restores the email messages to its email folder without copying the email message to archive queue 135 (step 320). Archive plug-in 120 then transmits any email messages having the appropriate criteria (step 330). In one embodiment, archive plug-in 120 transmits a copy of the requested email messages to email archive 150 (step 340). In another embodiment, archive plug-in 120 optionally compresses and/or encrypts the selected email messages (step 350), which may be subsequently uncompressed and/or unencrypted (step 360) when received by email account 130 (step 370).

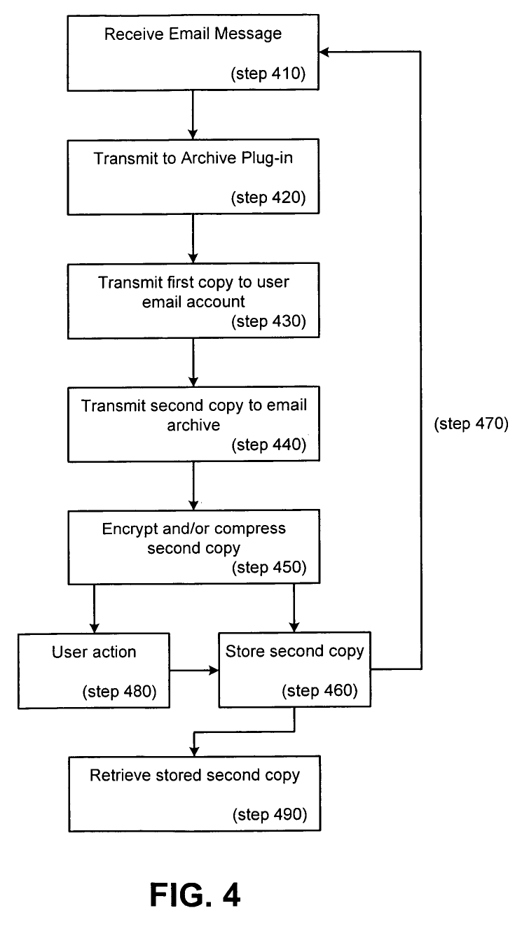

FIG. 4 is a flow diagram of another exemplary embodiment of a method 400 for backing up and retrieving email messages. In accordance with one exemplary embodiment of the invention, method 400 initiates when email server 115 receives one or more email messages from network 110 (step 410). The email message is then transmitted to archive plug-in 120 (step 420). Archive plug-in 120 transmits a first copy of the email message to email account 130 (step 430) and transmits a second copy to email archive 150 (step 440). The second copy may be compressed and/or encrypted (step 450) prior to being stored in email archive 150 (step 460). In one exemplary embodiment, the email message is stored as an individual file in email archive 150, whereas in other embodiments the email messages may be stored in a file containing multiple email messages including similar criteria (e.g., date, sender, and the like). The process of receiving and storing email messages (i.e., steps 410 through 460) may be repeated for each email message (step 470).

In one exemplary embodiment, the second copy of email messages are not stored until the user performs some action (i.e., reads, deletes, forwards, replies, and the like) on the first copy (step 480). When a user wishes to restore one or more email messages, the user requests archive plug-in 120 to retrieve one or more email messages based on criteria the user selects or pre-determined criteria under which the email messages were stored (step 490).

Notably, the term “transmit,” as used herein, may include sending electronic data (e.g., email messages) from one system component to another over a network connection. Additionally, as used herein, “data” or “email messages” may include encompassing information such as commands, queries, files, data for storage, and the like in digital or any other form.

System 100 and methods 200, 300, and 400 are described herein in terms of functional block components, optional selections, and various processing steps. It should be appreciated that such functional blocks may be realized by any number of hardware and/or software components configured to perform the specified functions. For example, system 100 may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, Macromedia Cold Fusion, Microsoft Active Server Pages, Java, COBOL, assembler, PERL, Visual Basic, SQL Stored Procedures, extensible markup language (XML), with the various algorithms being implemented with any combination of data structures, objects, processes, routines or other programming elements. Further, it should be noted that system 100 may employ any number of conventional techniques for data transmission, signaling, data processing, network control, and the like. Still further, system 100 could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

The user is equipped with a computing device in order to interact with system 100 and facilitate online commerce transactions. The user has a computing unit in the form of a personal computer, although other types of computing units may be used including laptops, notebooks, hand held computers (e.g., PDA, BlackBerry®, and the like), set-top boxes, cellular telephones, touch-tone telephones and the like.

System 100 and methods 200, 330, and 400 are described herein with reference to block diagrams and flowchart illustrations of apparatus (e.g., systems), methods, and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims or the invention. The scope of the invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises”, “comprising ”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical”.

I claim:

1. A computer-implemented method for backing up electronic mail (“email”) messages, comprising the steps of:
receiving a first email message at an email server;
transmitting, by said email server, said first email message to an email archive plug-in;
transmitting, by said email archive plug-in, a first copy of said first email message to an inbox of a user, said inbox located on an email platform;
transmitting, by said email archive plug-in, a second copy of said first email message to an email archive file index, wherein said email archive file index is located remotely from said email server and said email platform; and
storing said second copy in said email archive file index.

2. The computer-implemented method of claim 1, wherein said transmitting said first copy step and said transmitting said second copy step occur at substantially the same time.

3. The computer-implemented method of claim 1, wherein said transmitting said second copy step occurs in substantially real-time after said transmitting said first copy step.

4. The computer-implemented method of claim 1, wherein said transmitting said second copy step occurs prior to said user performing an action on said first copy.

5. The computer-implemented method of claim 1, further comprising the steps of:
receiving a second email message at said email server;
transmitting, by said email server, said second email message to said email archive plug-in;
transmitting, by said email archive plug-in, a third copy of said second email message to said inbox of said user;
transmitting, by said email archive plug-in, a fourth copy of said second email message to said email archive file index; and
storing said fourth copy in said email archive file index.

6. The computer-implemented method of claim 5, said storing said second copy step comprising the step of storing said second copy as a first individual file in said email archive file index, and said storing said fourth copy step comprising the step of storing said fourth copy as a second individual file in said email archive file index.

7. The computer-implemented method of claim 6, further comprising the step of:
retrieving at least one of said first individual file and said second individual file from said email archive file index subsequent to said user deleting at least one of said first copy and said third copy, respectively.

8. The computer-implemented method of claim 6, further comprising the step of:
retrieving at least one of said first individual file and said second individual file from said email archive file index subsequent to at least one of said first copy being lost and said third copy being lost, respectively.

9. The computer-implemented method of claim 1, wherein said first email message is one of encrypted, compressed, and encrypted and compressed and said second copy is correspondingly at least one of encrypted, compressed, and encrypted and compressed.

10. The computer-implemented method of claim 1, further comprising the step of:
at least one encrypting and compressing said second copy prior to said email archive file index storing said second copy.

11. A computer-readable medium comprising instructions, wherein said instructions, when read by a processor, cause said processor to perform the steps of:
receiving a first email message at an email server;
transmitting, by said email server, said first email message to an email archive plug-in;
transmitting, by said email archive plug-in, a first copy of said first email message to an inbox of a user, said inbox located on an email platform;
transmitting, by said email archive plug-in, a second copy of said first email message to an email archive file index, wherein said email archive file index is located remotely from said email server and said email platform; and
storing said second copy in said email archive file index.

12. The computer-readable medium of claim 11, wherein said transmitting said first copy step and said transmitting said second copy step occur at substantially the same time.

13. The computer-readable medium of claim 11, wherein said transmitting said second copy step occurs in substantially real-time after said transmitting said first copy step.

14. The computer-readable medium of claim 11, wherein said transmitting said second copy step occurs prior to said user performing an action on said first copy.

15. The computer-readable medium of claim 11, further comprising the steps of:
receiving a second email message at said email server;
transmitting, by said email server, said second email message to said email archive plug-in;
transmitting, by said email archive plug-in, a third copy of said second email message to said inbox of said user;
transmitting, by said email archive plug-in, a fourth copy of said second email message to said email archive file index; and
storing said fourth copy in said email archive file index.

16. The computer-readable medium of claim 15, said storing said second copy step comprising the step of storing said second copy as a first individual file in said email archive file index, and said storing said fourth copy step comprising the step of storing said fourth copy as a second individual file in said email archive file index.

17. The computer-readable medium of claim 16, further comprising the step of:
retrieving at least one of said first individual file and said second individual file from said email archive file index subsequent to said user deleting at least one of said first copy and said third copy, respectively.

18. The computer-readable medium of claim 16, further comprising the step of:
retrieving at least one of said first individual file and said second individual file from said email archive file index subsequent to at least one of said first copy being lost and said third copy being lost, respectively.

19. The computer-readable medium of claim 11, wherein said first email message is one of encrypted, compressed, and encrypted and compressed and said second copy is correspondingly at least one of encrypted, compressed, and encrypted and compressed.

20. A system to archive email messages, comprising:
an email server to receive email messages;
an email plug-in in communication with the email server; and
an email archive in communication with the email plug-in, wherein the email plug-in is configured to transmit a first copy of received email messages to an inbox of a user and to transmit a second copy of received email messages to the email archive for storage.
